(19) United States
(12) Patent Application Publication
(10) Pub. No.: US 2026/0012937 A1
(43) Pub. Date: Jan. 8, 2026

(54) TECHNIQUES FOR CLOSED-LOOP ANTENNA SELECTION IN WIRELESS COMMUNICATIONS

(71) Applicant: QUALCOMM Incorporated, San Diego, CA (US)

(72) Inventors: Hyojin LEE, San Diego, CA (US); Mostafa Khoshnevisan, San Diego, CA (US); Yu Zhang, San Diego, CA (US); Jing Jiang, San Diego, CA (US); Enoch Shiao-Kuang Lu, San Diego, CA (US); Jianming Zhu, Acton, MA (US)

(21) Appl. No.: 18/761,945

(22) Filed: Jul. 2, 2024

(51) Int. Cl. H04W 72/044; H04L 5/00

(52) U.S. Cl. CPC H04W 72/046; H04L 5/0048

(57) ABSTRACT

Aspects described herein relate to transmitting user equipment (UE) capability information related to a number of sounding reference signals (SRSs) to transmit for a number of antennas and a number of transmit chains at the UE, receiving a SRS configuration of SRS resources for transmitting the number of SRSs, transmitting the number of SRSs over the SRS resources, and receiving an antenna selection indication related to a set of one or more of the number of antennas to be associated to the number of transmit chains for performing antenna selection at the UE. Other aspects relate to receiving UE capability information, transmitting the SRS configuration, receiving the SRSs, and transmitting the antenna selection information.

### FIELD OF THE DISCLOSURE

Aspects of the present disclosure relate generally to wireless communication systems, and more particularly, to performing antenna selection at a wireless device.

### DESCRIPTION OF RELATED ART

Wireless communication systems are widely deployed to provide various types of communication content such as voice, video, packet data, messaging, broadcast, and so on. These systems may be multiple-access systems capable of supporting communication with multiple users by sharing the available system resources (e.g., time, frequency, and power). Examples of such multiple-access systems include code-division multiple access (CDMA) systems, time-division multiple access (TDMA) systems, frequency-division multiple access (FDMA) systems, and orthogonal frequency-division multiple access (OFDMA) systems, and single-carrier frequency division multiple access (SC-FDMA) systems.

These multiple access technologies have been adopted in various telecommunication standards to provide a common protocol that enables different wireless devices to communicate on a municipal, national, regional, and even global level. For example, a fifth generation (5G) wireless communications technology (which can be referred to as 5G new radio (5G NR)) is envisaged to expand and support diverse usage scenarios and applications with respect to current mobile network generations. In an aspect, 5G communications technology can include: enhanced mobile broadband addressing human-centric use cases for access to multimedia content, services and data; ultra-reliable-low latency communications (URLLC) with certain specifications for latency and reliability; and massive machine type communications, which can allow a very large number of connected devices and transmission of a relatively low volume of non-delay-sensitive information.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

According to an aspect, an apparatus for wireless communication is provided that includes a transceiver, one or more memories configured to, individually or in combination, store instructions, and one or more processors communicatively coupled with the one or more memories. The one or more processors are, individually or in combination, configured to execute the instructions to cause the apparatus to transmit, to a network node, user equipment (UE) capability information related to a number of sounding reference signals (SRSs) to transmit for a number of antennas and a number of transmit chains at the UE, receive, from the network node and based on the UE capability information, a SRS configuration of SRS resources for transmitting the number of SRSs, transmit the number of SRSs over the SRS resources, and receive, from the network node and based on transmitting the number of SRSs, an antenna selection indication related to a set of one or more of the number of antennas to be associated to the number of transmit chains for performing antenna selection at the apparatus.

In another aspect, an apparatus for wireless communication is provided that includes a transceiver, one or more memories configured to, individually or in combination, store instructions, and one or more processors communicatively coupled with the one or more memories. The one or more processors are, individually or in combination, configured to execute the instructions to cause the apparatus to receive, for a UE, UE capability information related to a number of SRSs to transmit for a number of antennas and a number of transmit chains at the UE, transmit, based on the UE capability information, a SRS configuration of SRS resources for transmitting the number of SRSs, receive, for the UE, the number of SRSs over the SRS resources, and transmit, based on receiving the number of SRSs, an antenna selection indication related to a set of one or more of the number of antennas to be associated to the number of transmit chains for performing antenna selection at the UE.

In another aspect, a method for wireless communication at a UE is provided that includes transmitting, to a network node, UE capability information related to a number of SRSs to transmit for a number of antennas and a number of transmit chains at the UE, receiving, from the network node and based on the UE capability information, a SRS configuration of SRS resources for transmitting the number of SRSs, transmitting the number of SRSs over the SRS resources, and receiving, from the network node and based on transmitting the number of SRSs, an antenna selection indication related to a set of one or more of the number of antennas to be associated to the number of transmit chains for performing antenna selection at the UE.

In another aspect, a method for wireless communication at a network node is provided that includes receiving, from a UE, UE capability information related to a number of SRSs to transmit for a number of antennas and a number of transmit chains at the UE, transmitting, based on the UE capability information, a SRS configuration of SRS resources for transmitting the number of SRSs, receiving, from the UE, the number of SRSs over the SRS resources, and transmitting, based on receiving the number of SRSs, an antenna selection indication related to a set of one or more of the number of antennas to be associated to the number of transmit chains for performing antenna selection at the UE.

In a further aspect, an apparatus for wireless communication is provided that includes a transceiver, a memory configured to store instructions, and one or more processors communicatively coupled with the transceiver and the memory. The one or more processors are configured to execute the instructions to perform the operations of methods described herein. In another aspect, an apparatus for wireless communication is provided that includes means for performing the operations of methods described herein. In yet another aspect, a computer-readable medium is provided including code executable by one or more processors to perform the operations of methods described herein.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 illustrates an example of a wireless communication system, in accordance with various aspects of the present disclosure;

FIG. 2 is a diagram illustrating an example of disaggregated base station architecture, in accordance with various aspects of the present disclosure;

FIG. 3 is a block diagram illustrating an example of a user equipment (UE), in accordance with various aspects of the present disclosure;

FIG. 4 is a block diagram illustrating an example of a base station, in accordance with various aspects of the present disclosure;

FIG. 5 is a flow chart illustrating an example of a method for transmitting sounding reference signals (SRSs) to a network node in antenna selection (AS), in accordance with aspects described herein;

FIG. 6 is a flow chart illustrating an example of a method for configuring a UE to transmit SRSs in AS, in accordance with aspects described herein;

FIG. 7 illustrates various examples of AS restriction bitmap bit positions and associated indicated possible antenna selections, in accordance with aspects described herein;

FIG. 8 illustrates various examples of AS restriction bitmap bit positions for multiple antenna and transmit chains and associated indicated possible antenna selections, in accordance with aspects described herein; and

FIG. 9 is a block diagram illustrating an example of a MIMO communication system including a base station and a UE, in accordance with various aspects of the present disclosure.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

The described features generally relate to performing antenna selection (AS) at a wireless node, such as a user equipment in fifth generation (5G) new radio (NR) or other wireless communication technologies, to communicate (e.g., transmit or receive) signals over a selection of antennas and/or corresponding antenna ports or transmit chains (e.g., transmit (Tx) chains or receive (Rx) chains). A chain can refer to a set of electronic components in a radio attached near the antenna for processing received signals, and may include one or more power amplifiers, switches, filters, etc. A chain can also be referred to herein as, or may include, a radio frequency (RF) front end. In 5G NR, for example, for uplink (UL), a UE can have a smaller number of Tx chains (e.g., a maximum number of baseband layers) than the number of antennas, and in some examples, the extra (unused) antennas may be available for Rx purpose (e.g., the UE can have more Rx chains employed than Tx chains). If the UE is capable of switching connection from chains to antennas, it may benefit from selecting the best set of antennas to be connected to the chains, depending on per-antenna Tx power budget, the overall propagation channel from UE baseband to gNB baseband, etc.

In an example, for codebook (CB)-based uplink multiple-input multiple-output (MIMO) in 5G NR, the UE can be configured (e.g., by a network node, such as a gNB) with sounding reference signal (SRS) resources for transmitting a SRS to the network node, which may allow the network node to select a precoding for transmitting signals to, or receiving signals from, the UE based on channel reciprocity. In one example, in CB-based UL MIMO in 5G NR, the UE can be configured with up to two SRS resources per set. Each resource in the set can have the same number of SRS ports. The gNB can transmit, and the UE can receive, an UL grant including a SRS resource indicator (SRI) value that selects one of the two resources. In addition, the UE can be configured (e.g., by a network node, such as a gNB) with a transmitted precoding matrix indicator (TPMI) that provides precoding information on the selected number of ports, p, SRS resources. In an example, CB-based uplink MIMO can be reused for performing antenna selection for a number, p, of chains and a number, q, of antennas, where two SRS resources each with p ports can be configured. In this example, each resource can correspond to a different connection case, which may be transparent to gNB. The gNB can select one from the two connections (each corresponding to each SRS resource) and indicate the selected connection to the UE using SRI. Though this approach may not have flexibility to support different connection cases from chains to antennas, it may be extended to increase a number of SRS resources to accommodate.

In another example, for non-codebook (NCB)-based uplink MIMO in 5G NR, the UE can be configured (e.g., by a network node, such as a gNB) with up to 8 SRS resources per set, where each resource has a single port. In uplink grant, the gNB can transmit, and the UE can receive, an SRI value that selects k of the configured SRS resources, where k<min(L_max, N_SRS), where L_max is the maximum number of layers that the UE is capable of and N_SRS is the number of SRS resources configured for NCB-based SRS resource set. In an example, NCB-based uplink MIMO can be reused for performing antenna selection for p chains and q antennas, where q single-port SRS resources each corresponding to each antenna can be configured, L_max can be set as p, and the gNB can choose up to p from the q resources. This approach may be used in non-coherent and fully connected AS architecture.

As described, for example, antenna switching SRS can be used for gNB to acquire downlink (DL) channel taking advantage of UL/DL reciprocity in time division duplexing (TDD). The UE can report, to the gNB, its possible capabilities on xTyR, where x is the number of Tx antenna ports and y is the number of Rx antenna ports. For xTyR, each SRS resource set can have y/x SRS resources transmitted in different symbols each with x ports, where each Tx chain can be capable of connecting to at least y/x antennas. Each x ports of each resource can be associated with a different UE antenna port. NR can support cases where y is a multiple of x. In 5G NR, however, there is no subsequent uplink transmission operation defined based on antenna switching SRS.

In 5G NR, UL AS is solely determined by UE in open-loop manner (e.g., and is transparent to gNB). The UE can determine the best set of antennas based on DL measurements and per-antenna power budget assuming some level of UL/DL reciprocity. There can be limitations in such open-loop UL AS, however, due to the mismatch between UL and DL on insertion loss, antenna correlation for TDD/frequency division duplexing (FDD) and/or propagation channel-related parameters especially in FDD. When the UE has a larger number of chains and antennas (which is a trend of UE improvement), the impact of such mismatch could be increased. Closed-loop antenna selection can be implemented in NR with CB-based or NCB-based based uplink MIMO in limited cases, as described. Aspects described herein relate to improving CB-based and NCB-based uplink MIMO frameworks and/or antenna switching SRS configuration to support more flexible closed-loop AS operation.

In various aspects described herein, the UE can transmit UE capability information to the network node (e.g., gNB) indicating a number of SRSs to transmit for a number of antennas and/or a number of transmit chains. The UE can receive, from the network node, a SRS configuration of SRS resources for transmitting the number of SRS to the network node, which can facilitate AS for the UE. For example, the gNB can accordingly receive the SRSs transmitted by the UE and can transmit, to the UE, AS information associated with a set of one or more of the number of antennas to be associated to the number of transmit chains for performing antenna selection at the UE. In this regard, closed-loop AS can be achieved for the UE without some limitations that may be associated with reusing CB-based and NCB-based uplink MIMO.

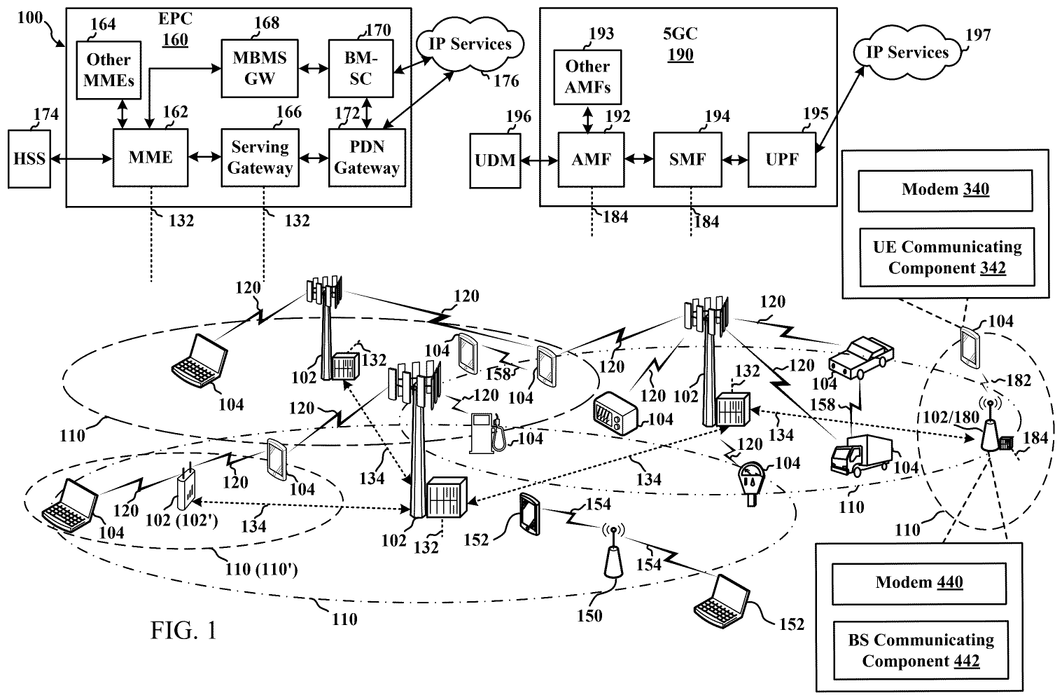

The described features will be presented in more detail below with reference to FIGS. 1-9.

As used in this application, the terms “component,” “module,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component can be localized on one computer and/or distributed between two or more computers. In addition, these components can execute from various computer readable media having various data structures stored thereon. The components can communicate by way of local and/or remote processes such as in accordance with a signal having one or more data packets, such as data from one component interacting with another component in a local system, distributed system, and/or across a network such as the Internet with other systems by way of the signal.

As used herein, a processor, at least one processor, and/or one or more processors, individually or in combination, configured to perform or operable for performing a plurality of actions is meant to include at least two different processors able to perform different, overlapping or non-overlapping subsets of the plurality actions, or a single processor able to perform all of the plurality of actions. In one non-limiting example of multiple processors being able to perform different ones of the plurality of actions in combination, a description of a processor, at least one processor, and/or one or more processors configured or operable to perform actions X, Y, and Z may include at least a first processor configured or operable to perform a first subset of X, Y, and Z (e.g., to perform X) and at least a second processor configured or operable to perform a second subset of X, Y, and Z (e.g., to perform Y and Z). Alternatively, a first processor, a second processor, and a third processor may be respectively configured or operable to perform a respective one of actions X, Y, and Z. It should be understood that any combination of one or more processors each may be configured or operable to perform any one or any combination of a plurality of actions.

As used herein, a memory, at least one memory, and/or one or more memories, individually or in combination, configured to store or having stored thereon instructions executable by one or more processors for performing a plurality of actions is meant to include at least two different memories able to store different, overlapping or non-overlapping subsets of the instructions for performing different, overlapping or non-overlapping subsets of the plurality actions, or a single memory able to store the instructions for performing all of the plurality of actions. In one non-limiting example of one or more memories, individually or in combination, being able to store different subsets of the instructions for performing different ones of the plurality of actions, a description of a memory, at least one memory, and/or one or more memories configured or operable to store or having stored thereon instructions for performing actions X, Y, and Z may include at least a first memory configured or operable to store or having stored thereon a first subset of instructions for performing a first subset of X, Y, and Z (e.g., instructions to perform X) and at least a second memory configured or operable to store or having stored thereon a second subset of instructions for performing a second subset of X, Y, and Z (e.g., instructions to perform Y and Z). Alternatively, a first memory, and second memory, and a third memory may be respectively configured to store or have stored thereon a respective one of a first subset of instructions for performing X, a second subset of instruction for performing Y, and a third subset of instructions for performing Z. It should be understood that any combination of one or more memories each may be configured or operable to store or have stored thereon any one or any combination of instructions executable by one or more processors to perform any one or any combination of a plurality of actions. Moreover, one or more processors may each be coupled to at least one of the one or more memories and configured or operable to execute the instructions to perform the plurality of actions. For instance, in the above non-limiting example of the different subset of instructions for performing actions X, Y, and Z, a first processor may be coupled to a first memory storing instructions for performing action X, and at least a second processor may be coupled to at least a second memory storing instructions for performing actions Y and Z, and the first processor and the second processor may, in combination, execute the respective subset of instructions to accomplish performing actions X, Y, and Z. Alternatively, three processors may access one of three different memories each storing one of instructions for performing X, Y, or Z, and the three processor may in combination execute the respective subset of instruction to accomplish performing actions X, Y, and Z. Alternatively, a single processor may execute the instructions stored on a single memory, or distributed across multiple memories, to accomplish performing actions X, Y, and Z.

Techniques described herein may be used for various wireless communication systems such as CDMA, TDMA, FDMA, OFDMA, single carrier-FDMA, and other systems. The terms “system” and “network” may often be used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A TDMA system may implement a radio technology such as Global System for Mobile Communications (GSM). An OFDMA system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM™, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A, and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies, including cellular (e.g., LTE) communications over a shared radio frequency spectrum band. The description below, however, describes an LTE/LTE-A system for purposes of example, and LTE terminology is used in much of the description below, although the techniques are applicable beyond LTE/LTE-A applications (e.g., to fifth generation (5G) new radio (NR) networks or other next generation communication systems).

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in other examples.

Various aspects or features will be presented in terms of systems that can include a number of devices, components, modules, and the like. It is to be understood and appreciated that the various systems can include additional devices, components, modules, etc. and/or may not include all of the devices, components, modules etc. discussed in connection with the figures. A combination of these approaches can also be used.

FIG. 1 is a diagram illustrating an example of a wireless communications system and an access network 100. The wireless communications system (also referred to as a wireless wide area network (WWAN)) can include base stations 102, UEs 104, an Evolved Packet Core (EPC) 160, and/or a 5G Core (5GC) 190. The base stations 102 may include macro cells (high power cellular base station) and/or small cells (low power cellular base station). The macro cells can include base stations. The small cells can include femtocells, picocells, and microcells. In an example, the base stations 102 may also include gNBs 180, as described further herein. In one example, some nodes of the wireless communication system may have a modem 340 and UE communicating component 342 for transmitting SRSs for AS based on a received SRS configuration, in accordance with aspects described herein. In addition, some nodes may have a modem 440 and BS communicating component 442 for configuring a UE to transmit SRSs for AS, in accordance with aspects described herein. Though a UE 104 is shown as having the modem 340 and UE communicating component 342 and a base station 102/gNB 180 is shown as having the modem 440 and BS communicating component 442, this is one illustrative example, and substantially any node or type of node may include a modem 340 and UE communicating component 342 and/or a modem 440 and BS communicating component 442 for providing corresponding functionalities described herein.

The base stations 102 configured for 4G LTE (which can collectively be referred to as Evolved Universal Mobile Telecommunications System (UMTS) Terrestrial Radio Access Network (E-UTRAN)) may interface with the EPC 160 through backhaul links 132 (e.g., using an S1 interface). The base stations 102 configured for 5G NR (which can collectively be referred to as Next Generation RAN (NG-RAN)) may interface with 5GC 190 through backhaul links 184. In addition to other functions, the base stations 102 may perform one or more of the following functions: transfer of user data, radio channel ciphering and deciphering, integrity protection, head compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or 5GC 190) with each other over backhaul links 134 (e.g., using an X2 interface). The backhaul links 134 may be wired or wireless.

The base stations 102 may wirelessly communicate with one or more UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macro cells may be referred to as a heterogeneous network. A heterogeneous network may also include Home Evolved Node Bs (eNBs) (HeNBs), which may provide service to a restricted group, which can be referred to as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (e.g., for x component carriers) used for transmission in the DL and/or the UL direction. The carriers may or may not be adjacent to each other. Allocation of carriers may be asymmetric with respect to DL and UL (e.g., more or less carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

In another example, certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

A base station 102, whether a small cell 102′ or a large cell (e.g., macro base station), may include an eNB, gNodeB (gNB), or other type of base station. Some base stations, such as gNB 180 may operate in a traditional sub 6 GHz spectrum, in millimeter wave (mmW) frequencies, and/or near mmW frequencies in communication with the UE 104. When the gNB 180 operates in mmW or near mmW frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band has extremely high path loss and a short range. The mmW base station 180 may utilize beamforming 182 with the UE 104 to compensate for the extremely high path loss and short range. A base station 102 referred to herein can include a gNB 180.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The 5GC 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 can be a control node that processes the signaling between the UEs 104 and the 5GC 190. Generally, the AMF 192 can provide QoS flow and session management. User Internet protocol (IP) packets (e.g., from one or more UEs 104) can be transferred through the UPF 195. The UPF 195 can provide UE IP address allocation for one or more UEs, as well as other functions. The UPF 195 is connected to the IP Services 197. The IP Services 197 may include the Internet, an intranet, an IP Multimedia Subsystem (IMS), a PS Streaming Service, and/or other IP services.

The base station may also be referred to as a gNB, Node B, evolved Node B (eNB), an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or 5GC 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). IoT UEs may include machine type communication (MTC)/enhanced MTC (eMTC, also referred to as category (CAT)-M, Cat M1) UEs, NB-IoT (also referred to as CAT NB1) UEs, as well as other types of UEs. In the present disclosure, eMTC and NB-IoT may refer to future technologies that may evolve from or may be based on these technologies. For example, eMTC may include FeMTC (further eMTC), eFeMTC (enhanced further eMTC), mMTC (massive MTC), etc., and NB-IoT may include eNB-IoT (enhanced NB-IoT), FeNB-IoT (further enhanced NB-IoT), etc. The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS, e.g., BS 102), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

In an example, UE communicating component 342 of a UE 104 can transmit UE capability information to a base station/gNB 102/180 related to a number of SRSs to transmit for a number of antennas and a number of transmit chains at the UE 104. BS communicating component 442 can receive the UE capability information and can generate a corresponding SRS configuration indicating SRS resources (e.g., time and/or frequency resources) for the UE 104 to use in transmitting SRS using different antenna/transmit chain combinations. UE communicating component 342 can transmit the SRSs over the SRS resources, and BS communicating component 442 can receive the SRSs and generate a AS indication for transmitting to the UE 104 to enable AS at the UE 104.

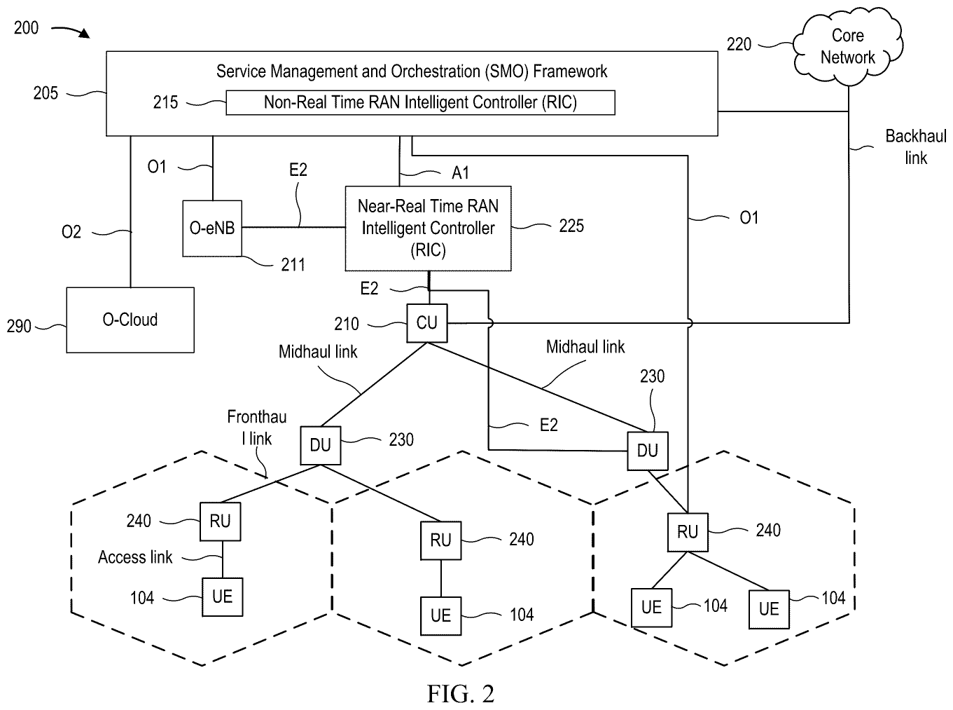

FIG. 2 shows a diagram illustrating an example of disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUS 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (i.e., Central Unit-User Plane (CU-UP)), control plane functionality (i.e., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the third Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communication with one or more UEs 104. In some implementations, real-time and non-real-time aspects of control and user plane communication with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

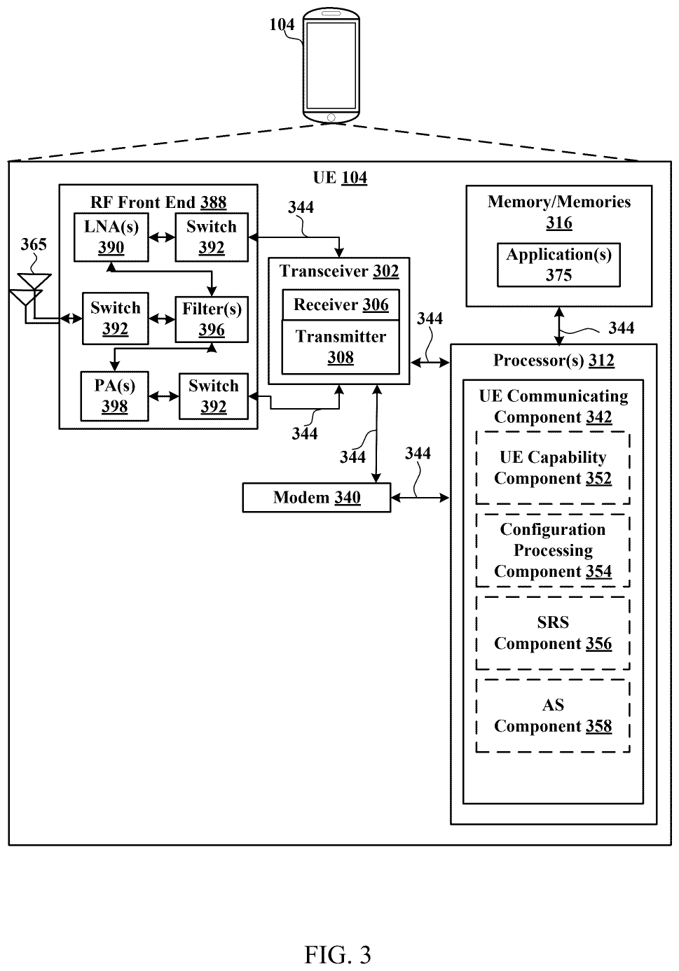

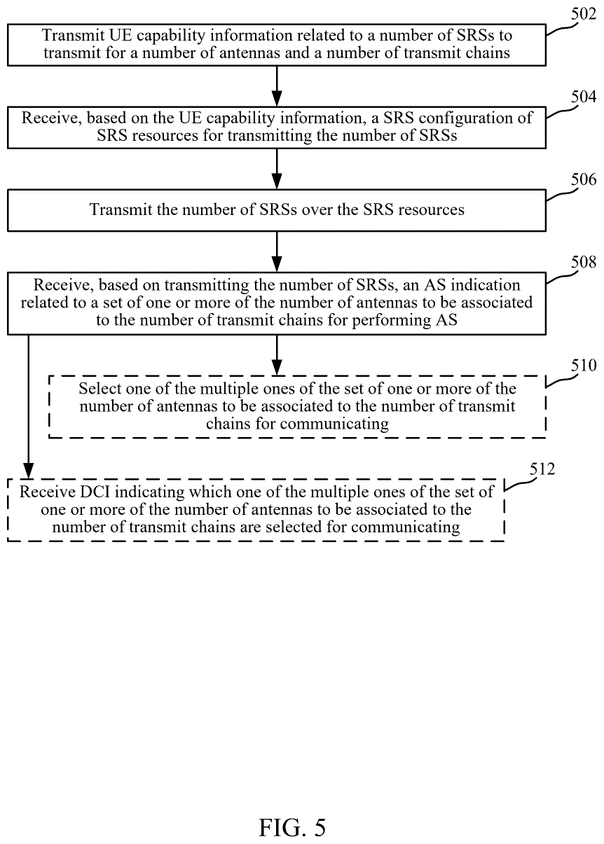

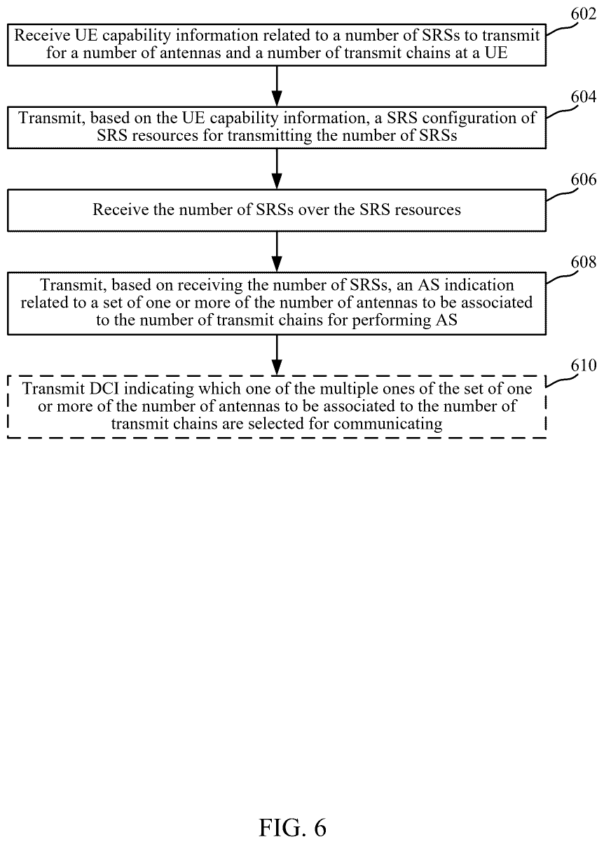

Turning now to FIGS. 3-9, aspects are depicted with reference to one or more components and one or more methods that may perform the actions or operations described herein, where aspects in dashed line may be optional. Although the operations described below in FIGS. 5 and 6 are presented in a particular order and/or as being performed by an example component, it should be understood that the ordering of the actions and the components performing the actions may be varied, depending on the implementation. Moreover, it should be understood that the following actions, functions, and/or described components may be performed by a specially programmed processor, a processor executing specially programmed software or computer-readable media, or by any other combination of a hardware component and/or a software component capable of performing the described actions or functions.

Referring to FIG. 3, one example of an implementation of UE 104 may include a variety of components, some of which have already been described above and are described further herein, including components such as one or more processors 312 and one or more memories 316 and one or more transceivers 302 in communication via one or more buses 344. For example, the one or more processors 312 can include a single processor or multiple processors configured to perform one or more functions described herein. For example, the multiple processors can be configured to perform a certain subset of a set of functions described herein, such that the multiple processors together can perform the set of functions. Similarly, for example, the one or more memories 316 can include a single memory device or multiple memory devices configured to store instructions or parameters for performing one or more functions described herein. For example, the multiple memory devices can be configured to store the instructions or parameters for performing a certain subset of a set of functions described herein, such that the multiple memory devices together can store the instructions or parameters for the set of functions. The one or more processors 312, one or more memories 316, and one or more transceivers 302 may operate in conjunction with modem 340 and/or UE communicating component 342 for transmitting SRSs for AS based on a received SRS configuration, in accordance with aspects described herein.

In an aspect, the one or more processors 312 can include a modem 340 and/or can be part of the modem 340 that uses one or more modem processors. Thus, the various functions related to UE communicating component 342 may be included in modem 340 and/or processors 312 and, in an aspect, can be executed by a single processor, while in other aspects, different ones of the functions may be executed by a combination of two or more different processors. For example, in an aspect, the one or more processors 312 may include any one or any combination of a modem processor, or a baseband processor, or a digital signal processor, or a transmit processor, or a receiver processor, or a transceiver processor associated with transceiver 302. In other aspects, some of the features of the one or more processors 312 and/or modem 340 associated with UE communicating component 342 may be performed by transceiver 302.

Also, memory/memories 316 may be configured to store data used herein and/or local versions of applications 375 or UE communicating component 342 and/or one or more of its subcomponents being executed by at least one processor 312. Memory/memories 316 can include any type of computer-readable medium usable by a computer or at least one processor 312, such as random access memory (RAM), read only memory (ROM), electronically erasable programmable ROM (EEPROM), tapes, volatile memory, non-volatile memory, optical disk storage, magnetic disk storage, other magnetic storage devices, combinations of the aforementioned types of computer-readable media, or any other medium that can be used to store computer executable code in the form of instructions or data structures that can be accessed by a computer. In an aspect, for example, memory/memories 316 may be a non-transitory computer-readable storage medium that stores one or more computer-executable codes defining UE communicating component 342 and/or one or more of its subcomponents, and/or data associated therewith, when UE 104 is operating at least one processor 312 to execute UE communicating component 342 and/or one or more of its subcomponents.

Transceiver 302 may include at least one receiver 306 and at least one transmitter 308. Receiver 306 may include hardware, firmware, and/or software code executable by a processor for receiving data, the code comprising instructions and being stored in a memory (e.g., computer-readable medium). Receiver 306 may be, for example, a radio frequency (RF) receiver. In an aspect, receiver 306 may receive signals transmitted by at least one base station 102. Additionally, receiver 306 may process such received signals, and also may obtain measurements of the signals, such as, but not limited to, Ec/Io, signal-to-noise ratio (SNR), signal-to-interference-and-noise ratio (SINR), reference signal received power (RSRP), reference signal received quality (RSRQ), received signal strength indicator (RSSI), etc. Transmitter 308 may include hardware, firmware, and/or software code executable by a processor for transmitting data, the code comprising instructions and being stored in a memory (e.g., computer-readable medium). A suitable example of transmitter 308 may including, but is not limited to, an RF transmitter.

Moreover, in an aspect, UE 104 may include RF front end 388, which may operate in communication with one or more antennas 365 and transceiver 302 for receiving and transmitting radio transmissions, for example, wireless communications transmitted by at least one base station 102 or wireless transmissions transmitted by UE 104. RF front end 388 may be connected to one or more antennas 365 and can include one or more low-noise amplifiers (LNAs) 390, one or more switches 392, one or more power amplifiers (PAS) 398, and one or more filters 396 for transmitting and receiving RF signals.

In an aspect, LNA 390 can amplify a received signal at a desired output level. In an aspect, each LNA 390 may have a specified minimum and maximum gain values. In an aspect, RF front end 388 may use one or more switches 392 to select a particular LNA 390 and its specified gain value based on a desired gain value for a particular application.

Further, for example, one or more PA(s) 398 may be used by RF front end 388 to amplify a signal for an RF output at a desired output power level. In an aspect, each PA 398 may have specified minimum and maximum gain values. In an aspect, RF front end 388 may use one or more switches 392 to select a particular PA 398 and its specified gain value based on a desired gain value for a particular application.

Also, for example, one or more filters 396 can be used by RF front end 388 to filter a received signal to obtain an input RF signal. Similarly, in an aspect, for example, a respective filter 396 can be used to filter an output from a respective PA 398 to produce an output signal for transmission. In an aspect, each filter 396 can be connected to a specific LNA 390 and/or PA 398. In an aspect, RF front end 388 can use one or more switches 392 to select a transmit or receive path using a specified filter 396, LNA 390, and/or PA 398, based on a configuration as specified by transceiver 302 and/or processor 312.

As such, transceiver 302 may be configured to transmit and receive wireless signals through one or more antennas 365 via RF front end 388. In an aspect, transceiver may be tuned to operate at specified frequencies such that UE 104 can communicate with, for example, one or more base stations 102 or one or more cells associated with one or more base stations 102. In an aspect, for example, modem 340 can configure transceiver 302 to operate at a specified frequency and power level based on the UE configuration of the UE 104 and the communication protocol used by modem 340.

In an aspect, modem 340 can be a multiband-multimode modem, which can process digital data and communicate with transceiver 302 such that the digital data is sent and received using transceiver 302. In an aspect, modem 340 can be multiband and be configured to support multiple frequency bands for a specific communications protocol. In an aspect, modem 340 can be multimode and be configured to support multiple operating networks and communications protocols. In an aspect, modem 340 can control one or more components of UE 104 (e.g., RF front end 388, transceiver 302) to enable transmission and/or reception of signals from the network based on a specified modem configuration. In an aspect, the modem configuration can be based on the mode of the modem and the frequency band in use. In another aspect, the modem configuration can be based on UE configuration information associated with UE 104 as provided by the network during cell selection and/or cell reselection.

In an aspect, UE communicating component 342 can optionally include a UE capability component 352 for transmitting UE capability information to a network node, a configuration processing component 354 for processing a configuration received from the network node indicating SRS resources for transmitting SRSs, a SRS component 356 for transmitting SRSs over the configured SRS resources, and/or an AS component 358 for performing AS, in accordance with aspects described herein.

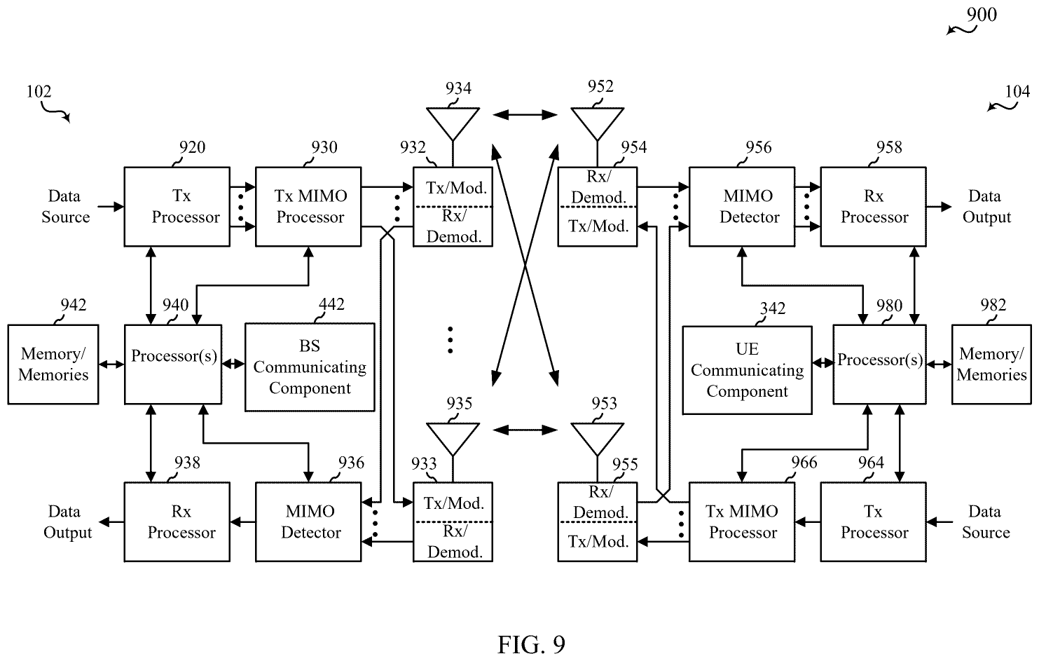

In an aspect, the processor(s) 312 may correspond to one or more of the processors described in connection with the UE in FIG. 9. Similarly, the memory/memories 316 may correspond to the one or more memories described in connection with the UE in FIG. 9.

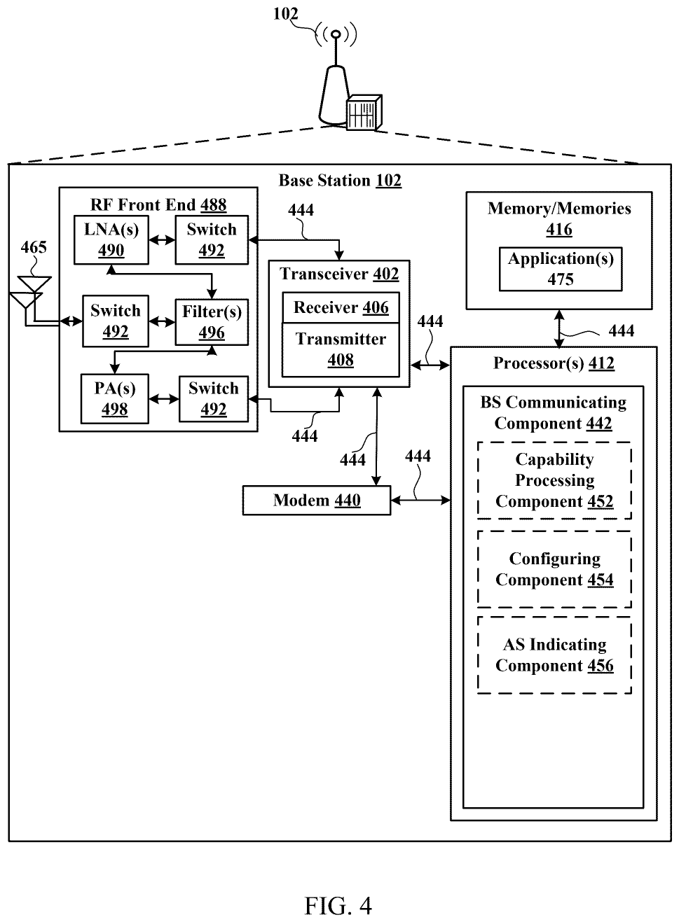

Referring to FIG. 4, one example of an implementation of base station 102 (e.g., a base station 102 and/or gNB 180, as described above) may include a variety of components, some of which have already been described above, but including components such as one or more processors 412 and one or more memories 416 and one or more transceivers 402 in communication via one or more buses 444. For example, the one or more processors 412 can include a single processor or multiple processors configured to perform one or more functions described herein. For example, the multiple processors can be configured to perform a certain subset of a set of functions described herein, such that the multiple processors together can perform the set of functions. Similarly, for example, the one or more memories 416 can include a single memory device or multiple memory devices configured to store instructions or parameters for performing one or more functions described herein. For example, the multiple memory devices can be configured to store the instructions or parameters for performing a certain subset of a set of functions described herein, such that the multiple memory devices together can store the instructions or parameters for the set of functions. The one or more processors 412, one or more memories 416, and one or more transceivers 402 may operate in conjunction with modem 440 and/or BS communicating component 442 for configuring a UE to transmit SRSs for AS, in accordance with aspects described herein.

The transceiver 402, receiver 406, transmitter 408, one or more processors 412, memory/memories 416, applications 475, buses 444, RF front end 488, LNAs 490, switches 492, filters 496, PAs 498, and one or more antennas 465 may be the same as or similar to the corresponding components of UE 104, as described above, but configured or otherwise programmed for base station operations as opposed to UE operations.

In an aspect, BS communicating component 442 can optionally include a capability processing component 452 for processing capability information received from a UE, a configuring component 454 for configuring the UE with SRS resources for transmitting SRSs, and/or a AS indicating component 456 for transmitting an AS indication to the UE, in accordance with aspects described herein.

In an aspect, the processor(s) 412 may correspond to one or more of the processors described in connection with the base station in FIG. 9. Similarly, the memory/memories 416 may correspond to the one or more memories described in connection with the base station in FIG. 9.

FIG. 5 illustrates a flow chart of an example of a method 500 for transmitting SRSs to a network node in AS, in accordance with aspects described herein. FIG. 6 illustrates a flow chart of an example of a method 600 for configuring a UE to transmit SRSs in AS, in accordance with aspects described herein. In an example, a UE 104 can perform the functions described in method 500 shown in FIG. 5 using one or more of the components described in FIGS. 1 and/or 3. In an example, a node scheduling the UE 104 with communication resources, such as a base station 102 or gNB 180, a monolithic base station or gNB, a portion of a disaggregated base station or gNB, a UE in sidelink communication, etc., can perform the functions described in method 600 shown in FIG. 6 using one or more of the components described in FIGS. 1 and/or 4. Methods 500 and 600 are described in conjunction with one another for ease of explanation; however, the methods 500 and 600 are not required to be performed together and indeed can be performed independently using separate devices.

In method 500, at Block 502, UE capability information related to a number of SRSs to transmit for a number of antennas and a number of transmit chains can be transmitted. In an aspect, UE capability component 352, e.g., in conjunction with processor(s) 312, memory/memories 316, transceiver 302, UE communicating component 342, etc., can transmit (e.g., to a network node) UE capability information related to a number of SRSs to transmit for a number of antennas and a number of transmit chains. For example, UE capability component 352 can transmit the UE capability information to the network node in radio resource control (RRC) signaling, such as remaining minimum system information (RMSI) or other RRC signaling from the UE to the network node, in dynamic uplink control information (UCI) transmitted over a physical uplink control channel (PUCCH) or physical uplink shared channel (PUSCH)< and/or the like. In accordance with various aspects described herein, the UE capability information can include an indication of a number of transmit chains supported by the UE, a number of AS cases supported by the UE, a number of antennas supported by the UE, an AS restriction indicating which Ass (e.g., which combinations of antennas and chains) are supported, a switching gap between SRS resources to guarantee enough time for switching between different connections, etc.

In method 600, at Block 602, UE capability information related to a number of SRSs to transmit for a number of antennas and a number of transmit chains can be received. In an aspect, capability processing component 452, e.g., in conjunction with processor(s) 412, memory/memories 416, transceiver 402, BS communicating component 442, etc., can receive (e.g., for or from a UE) and/or process UE capability information related to a number of SRSs to transmit for a number of antennas and a number of transmit chains. For example, capability processing component 452 can receive the UE capability information from a UE 104 in RRC signaling, such as RMSI, UCI, etc., from the UE 104, as described.

In method 600, at Block 604, a SRS configuration of SRS resources for transmitting the number of SRSs can be transmitted based on the UE capability information. In an aspect, configuring component 454, e.g., in conjunction with processor(s) 412, memory/memories 416, transceiver 402, BS communicating component 442, etc., can generate and/or transmit, based on the UE capability information, the SRS configuration of SRS resources for transmitting the number of SRS. For example, configuring component 454 can configure the SRS resources for the UE 104 based on the UE capability information to include SRS resources for transmitting SRSs using the various combinations of antennas and chains (or AS cases) at the UE 104, as described further herein. In an example, configuring component 454 can transmit the SRS configuration using RRC signaling, media access control-control element (MAC-CE), downlink control information (DCI) transmitted over physical downlink control channel (PDCCH) or physical downlink shared channel (PDSCH), etc. The SRS configuration can indicate, for example, a number of SRS resources (e.g., time and/or frequency resources) over which the UE 104 can transmit the various SRSs.

In method 500, at Block 504, a SRS configuration of SRS resources for transmitting the number of SRSs can be received based on the UE capability information. In an aspect, configuration processing component 354, e.g., in conjunction with processor(s) 312, memory/memories 316, transceiver 302, UE communicating component 342, etc., can receive and/or process, based on the UE capability information, the SRS configuration of SRS resources for transmitting the number of SRSs. For example, configuration processing component 354 can receive the SRS configuration in the RRC signaling, MAC-CE, DCI, etc., as described above.

In method 500, at Block 506, the number of SRSs can be transmitted over the SRS resources. In an aspect, SRS component 356, e.g., in conjunction with processor(s) 312, memory/memories 316, transceiver 302, UE communicating component 342, etc., can generate and/or transmit the number of SRSs over the SRS resources. For example, SRS component 356 can transmit the number of SRSs by transmitting, of each of the SRS resources, an SRS using a different combination of antenna and transmit chain, e.g., as based on the number of combinations indicated in the UE capability information.

In method 600, at Block 606, the number of SRSs can be received over the SRS resources. In an aspect, BS communicating component 442, e.g., in conjunction with processor(s) 412, memory/memories 416, transceiver 402, etc., can receive the number of SRSs over the SRS resources. In this example, AS indicating component 456 can select, based on measurements or other properties of the received SRSs, one or more sets of antenna selection (e.g., one or more sets of antenna and transmit chain combination) for communicating with the UE 104.

In method 600, at Block 608, an AS indication related to a set of one or more of the number of antennas to be associated to the number of transmit chains for performing AS can be transmitted based on receiving the number of SRSs. In an aspect, AS indicating component 456, e.g., in conjunction with processor(s) 412, memory/memories 416, transceiver 402, BS communicating component 442, etc., can generate and/or transmit, based on receiving the number of SRSs (e.g., from the UE 104), the AS indication related to the set of one or more of the number of antennas to be associated to the number of transmit chains for performing AS. For example, AS indicating component 456 can transmit the AS indication in MAC-CE, DCI, etc., which may include an indication of a set of selected antenna and transmit chain combinations (e.g., based on a selected corresponding SRS or SRS resource over which the corresponding SRS is received), an indication of a single antenna and transmit chain combination (e.g., as an index within the set or otherwise), and/or the like.

In method 500, at Block 508, an AS indication related to a set of one or more of the number of antennas to be associated to the number of transmit chains can be received, based on transmitting the number of SRSs, for performing AS. In an aspect, AS component 358, e.g., in conjunction with processor(s) 312, memory/memories 316, transceiver 302, UE communicating component 342, etc., can receive and/or process, based on transmitting the number of SRSs, the AS indication related to the set of one or more of the number of antennas to be associated to the number of transmit chains for performing AS for communicating with (e.g., transmitting signals to or receiving signals from) the network node. For example, AS component 358 can receive the AS indication in MAC-CE, DCI, etc., which may include an indication of a set of selected antenna and transmit chain combinations (e.g., based on a selected corresponding SRS or SRS resource over which the corresponding SRS is received), an indication of a single antenna and transmit chain combination (e.g., as an index within the set or otherwise), and/or the like. In any case, for example, UE communicating component 342 can then transmit signals to the network node using the selected AS combinations.

In a first example, AS utilizing CB-based UL MIMO framework can be modified such that UE capability component 352 can transmit, and capability processing component 452 can receive and/or process, UE capability information indicating one or more of a number of chains, p (e.g., as equivalent to number of SRS ports), a number of AS cases, N (e.g., as equivalent to number of SRS resources), and/or a switching gap between SRS resources to guarantee switching between different connections. In an example, in case of a disjoint connection for two chains and four antennas (e.g., where one chain can connect to antenna 0 or 1 and one chain can connect to antenna 2 or 3), there can be 4 AS cases—(0, 2), (0, 3), (1,2), (1,3)—and 4 SRS resources each with 2 ports can be configured to support these cases. In addition, for example, N for SRS configuration (N_{RRC}) may be different from N for capability signaling (N_{CAP}), satisfying N_{RRC}<=N_{CAP}.

In this example, configuring component 454 can generate and/or transmit a SRS configuration to configure SRS resources for the number of SRSs pertaining to the different AS cases. For example, the UE 104 can be configured with (TDMed) N SRS resources each with p ports guaranteeing switching gap between resources. Configuration processing component 354 can receive and process the configuration to determine the SRS resources, and SRS component 356 can transmit the SRSs using the different AS cases over the SRS resources. BS communicating component 442 can process the SRSs, and AS indicating component 456 can determine a set of AS or a single AS to configure the UE 104 for communicating with the network node. For example, AS indicating component 456 can select s sets of antenna selection results, where s can be configured by the network node or otherwise defined in the wireless communication technology (e.g., 5G NR specification). In an example, AS indicating component 456 can transmit, in MAC-CE, DCI, etc., AS indication signaling to the UE 104 having a bit width of ┌s log₂ N┐, and AS component 358 can receive and/or process the AS indication signaling to determine an AS for communicating with the network node. For example, the AS indication signaling can indicate an index of SRS resource(s) corresponding to a selected AS(s). For example, AS component 358 can select the AS based on determining the AS used to transmit the SRS in the corresponding SRS resource(s) indicated by the AS indication signaling.

In one example, where AS indicating component 456 transmits the MAC-CE indicating the s sets, UE select one of the AS in the s sets to use in communicating with the network node. In method 500, optionally at Block 510, one of the multiple ones of the set of one or more of the number of antennas to be associated to the number of transmit chains for communicating can be selected. In an aspect, AS component 358, e.g., in conjunction with processor(s) 312, memory/memories 316, transceiver 302, UE communicating component 342, etc., can select one of the multiple ones of the set of one or more of the number of antennas to be associated to the number of transmit chains for communicating with the network node.

In another example, where AS indicating component 456 transmits the DCI indicating the s sets, s can be one, and the AS field in DCI can be used to signal the selected AS (e.g., using SRI or other field). In method 600, optionally at Block 610, DCI indicating which one of the multiple ones of the set of one or more of the number of antennas to be associated to the number of transmit chains are selected for communicating can be transmitted. In an aspect, AS indicating component 456, e.g., in conjunction with processor(s) 412, memory/memories 416, transceiver 402, BS communicating component 442, etc., can transmit, DCI indicating which one of the multiple ones of the set of one or more of the number of antennas to be associated to the number of transmit chains are selected for communicating with the network node. In method 500, optionally at Block 512, DCI indicating which one of the multiple ones of the set of one or more of the number of antennas to be associated to the number of transmit chains are selected for communicating can be received. In an aspect, AS component 358, e.g., in conjunction with processor(s) 312, memory/memories 316, transceiver 302, UE communicating component 342, etc., can receive DCI indicating which one of the multiple ones of the set of one or more of the number of antennas to be associated to the number of transmit chains are selected for communicating with the network node.

In yet another example, AS indicating component 456 can transmit MAC-CE with AS set indication signaling having bit width of ┌s log₂ N┐, and can then transmit DCI indicating one of the AS results (e.g., the best AS) having a bit width of ┌log₂ s┐, which can be the SRI field.

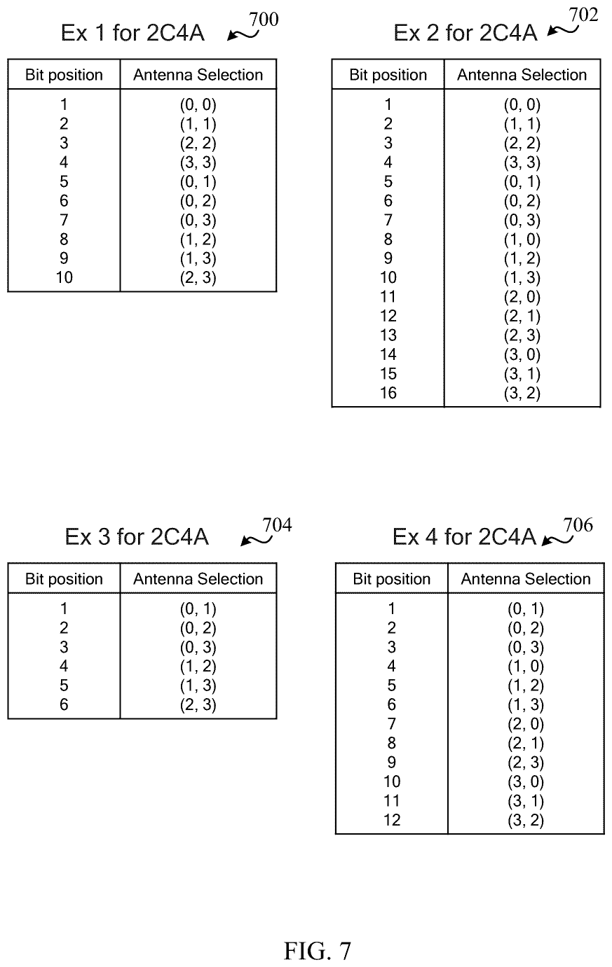

In a second example, AS utilizing NCB-based UL MIMO framework can be modified such that UE capability component 352 can transmit, and capability processing component 452 can receive and/or process, UE capability information indicating a number of chains, p (e.g., equivalent to number of supported layers and number of simultaneous transmitted SRS resources), a number of antennas, q (e.g., equivalent to number of supported SRS resources per set), an AS restriction with N-bit bitmap (e.g., having a size of N bits) of which each bit indicates whether a certain selection (or connection) is supported, and/or a switching gap between SRS resources to guarantee switching between different connections. Examples of bitmap bit positions and associated indicated antenna selections are shown in FIG. 7.

FIG. 7 illustrates various examples of AS restriction bitmap bit positions and associated indicated possible antenna selections (or connections from chains to antennas), in accordance with aspects described herein. In a first example, the AS restriction bitmap, also referred to herein as antenna switching support bitmap, can include N bits, where

$$N = {\sum }_{k = 1}^{p} C ( q , k )$$

if there is no constraint on the order of antenna selections and if overlap is permitted (e.g., if one antenna can be used by multiple chains, or overlapping of antennas among chains is otherwise permitted). For example, example 1 700 in FIG. 7 illustrates the possible bit positions for a case of two transmit chains and four antennas where there is no constraint on the order of antenna selections and where overlap is permitted. Each antenna selection can indicate the antenna selected for the first and second transmit chain. For example, antenna selection (0, 2) can indicate antenna 0 for a first one of the two transmit chains and antenna 2 for a second one of the two transmit chains. In a second example, the AS restriction bitmap can include N bits, where

$$N = {\sum }_{k = 1}^{p} P ( q , k )$$

if there is a constraint on the order of antenna selections and if overlap is permitted. For example, example 2 702 in FIG. 7 illustrates the possible bit positions for a case of two transmit chains and four antennas where there is a constraint on the order of antenna selections and where overlap is permitted. In a third example, the AS restriction bitmap can include N bits, where N=C(q,p) if there is no constraint on the order of antenna selections and if overlap is not permitted. For example, example 3 704 in FIG. 7 illustrates the possible bit positions for a case of two transmit chains and four antennas where there is no constraint on order of antenna selections and where overlap is not permitted. In a fourth example, the AS restriction bitmap can include N bits, where N=P(q,p) if there is a constraint on the order of antenna selections and if overlap is not permitted. For example, example 4 706 in FIG. 7 illustrates the possible bit positions for a case of two transmit chains and four antennas where there is a constraint on order of antenna selections and where overlap is not permitted.

In these examples, configuring component 454 can generate and/or transmit a SRS configuration to configure SRS resources for the number of SRSs indicated in the AS restriction bitmap (e.g., the number of bits set to one in the bitmap). For example, the UE can be configured with q SRS resources each with a single port. p SRS resource combinations that are not indicated as ‘not used’ in AS restriction bitmap (e.g., having a bit value of zero) can be simultaneously transmitted at one symbol. In any case, SRS component 356 can transmit the SRSs using the ASs indicated as used in the AS restriction bitmap over the SRS resources. BS communicating component 442 can receive the SRSs, as described, and AS indicating component 456 can select s sets of k (≤p) SRS resources, where s can be configured by the network node or otherwise defined in the wireless communication technology (e.g., 5G NR specification). For example, AS indicating component 456 can indicate the selected s sets, as described above (e.g., using MAC-CE and/or DCI signaling). For example, AS indicating component 456 can calculate N using one of the equations described with reference to FIG. 7 above (e.g., possibly using a different alternative from capability reporting), and can transmit a bitmap having N bits to indicate AS selections, as described above. In an example, AS component 358 can select one of the indicated ASs or can receive a DCI indicating an index of the selected one of the indicated ASs (e.g., where a MAC-CE includes the bitmap), as described above. In one example, when the UE is configured by AS restriction, UE may not be expected to be signaled with antenna selection that is indicated as ‘not used’ in AS restriction bitmap.

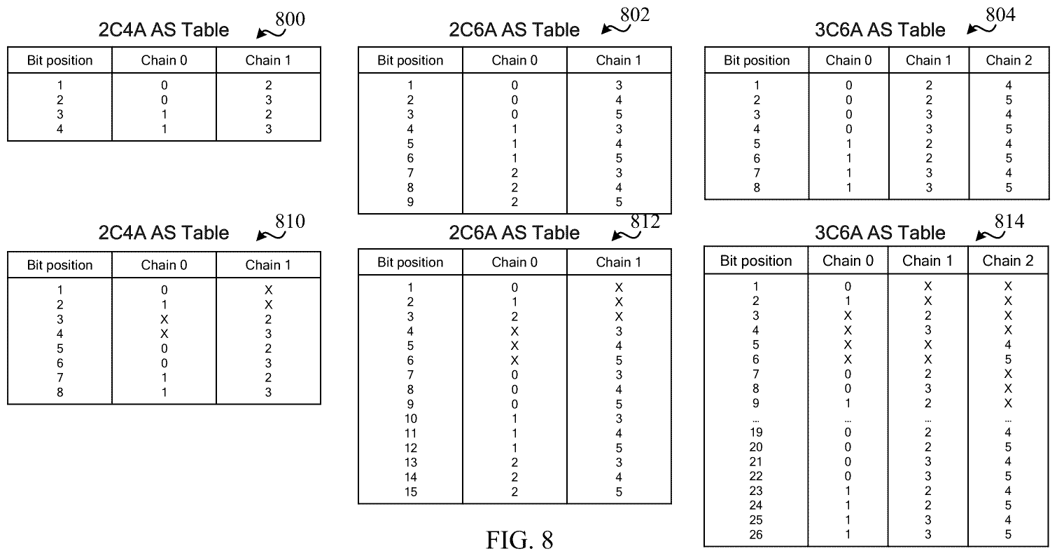

In a third example, AS utilizing antenna switching SRS framework can be modified such that UE capability component 352 can transmit, and capability processing component 452 can receive and/or process, UE capability information indicating a number of chains and a number of antennas, pCqA (e.g., which can be equivalent to xTyR), an AS restriction with N-bit bitmap of which each bit indicates whether to support a certain selection (or connection), and/or a switching gap between SRS resources. For example, antenna switching SRS can assume that each chain is connected to y/x antennas and y/x is an integer. Examples of bitmap bit positions and associated indicated antenna selections are shown in FIG. 8.

FIG. 8 illustrates various examples of AS restriction bitmap bit positions for multiple antenna and transmit chains and associated indicated possible antenna selections (or connections), in accordance with aspects described herein. In a first example, the AS restriction bitmap, antenna switching support bitmap, can include N bits, where

$$N = {( \frac{q}{p} )}^{p}$$

if each chain is connected to at least one antenna. For example, example 800 illustrates the possible bit positions for a case of two transmit chains and four antennas if each chain is connected to at least one antenna, example 802 illustrates the possible bit positions for a case of two transmit chains and six antennas if each chain is connected to at least one antenna, and example 804 illustrates the possible bit positions for a case of three transmit chains and six antennas if each chain is connected to at least one antenna. In a second example, the AS restriction bitmap can include N bits, where

$$N = {( \frac{q}{p} + 1 )}^{p} - 1$$

if unused chains are allowed. For example, example 810 illustrates the possible bit positions for a case of two transmit chains and four antennas if unused chains are allowed, example 812 illustrates the possible bit positions for a case of two transmit chains and six antennas if unused chains are allowed, and example 814 illustrates the possible bit positions for a case of three transmit chains and six antennas if unused chains are allowed.

In these examples, configuring component 454 can generate and/or transmit a SRS configuration to configure q/p SRS resources, each with p ports. SRS component 356 can transmit the SRSs using the ASs indicated as used in the AS restriction bitmap over the SRS resources. BS communicating component 442 can receive the SRSs, as described, and AS indicating component 456 can select s sets, as described herein. For example, AS indicating component 456 can indicate the selected s sets, as described above (e.g., using MAC-CE and/or DCI signaling). For example, AS indicating component 456 can calculate N using one of the equations described with reference to FIG. 8 above (e.g., possibly using a different alternative from capability reporting), and can transmit a bitmap having bit width given by ┌s log₂ N┐, where

$$N = {( \frac{q}{p} )}^{p} or N = {( \frac{q}{p} + 1 )}^{p} - 1$$

to indicate AS selections, as described above. In an example, AS component 358 can select one of the indicated ASs or can receive a DCI indicating an index of the selected one of the indicated ASs (e.g., where a MAC-CE includes the bitmap), as described above. In one example, when the UE is configured by AS restriction, UE may not be expected to be signaled with antenna selection that is indicated as ‘not used’ in AS restriction bitmap.

FIG. 9 is a block diagram of a MIMO communication system 900 including a base station 102 and a UE 104. The MIMO communication system 900 may illustrate aspects of the wireless communication access network 100 described with reference to FIG. 1. The base station 102 may be an example of aspects of the base station 102 described with reference to FIG. 1. The base station 102 may be equipped with antennas 934 and 935, and the UE 104 may be equipped with antennas 952 and 953. In the MIMO communication system 900, the base station 102 may be able to send data over multiple communication links at the same time. Each communication link may be called a “layer” and the “rank” of the communication link may indicate the number of layers used for communication. For example, in a 2×2 MIMO communication system where base station 102 transmits two “layers,” the rank of the communication link between the base station 102 and the UE 104 is two.

At the base station 102, a transmit (Tx) processor 920 may receive data from a data source. The transmit processor 920 may process the data. The transmit processor 920 may also generate control symbols or reference symbols. A transmit MIMO processor 930 may perform spatial processing (e.g., precoding) on data symbols, control symbols, or reference symbols, if applicable, and may provide output symbol streams to the transmit modulator/demodulators 932 and 933. Each modulator/demodulator 932 through 933 may process a respective output symbol stream (e.g., for OFDM, etc.) to obtain an output sample stream. Each modulator/demodulator 932 through 933 may further process (e.g., convert to analog, amplify, filter, and upconvert) the output sample stream to obtain a DL signal. In one example, DL signals from modulator/demodulators 932 and 933 may be transmitted via the antennas 934 and 935, respectively.

The UE 104 may be an example of aspects of the UEs 104 described with reference to FIGS. 1 and 3. At the UE 104, the UE antennas 952 and 953 may receive the DL signals from the base station 102 and may provide the received signals to the modulator/demodulators 954 and 955, respectively. Each modulator/demodulator 954 through 955 may condition (e.g., filter, amplify, downconvert, and digitize) a respective received signal to obtain input samples. Each modulator/demodulator 954 through 955 may further process the input samples (e.g., for OFDM, etc.) to obtain received symbols. A MIMO detector 956 may obtain received symbols from the modulator/demodulators 954 and 955, perform MIMO detection on the received symbols, if applicable, and provide detected symbols. A receive (Rx) processor 958 may process (e.g., demodulate, deinterleave, and decode) the detected symbols, providing decoded data for the UE 104 to a data output, and provide decoded control information to a processor(s) 980, or memory/memories 982.

The processor(s) 980 may in some cases execute stored instructions to instantiate a UE communicating component 342 (see e.g., FIGS. 1 and 3).

On the uplink (UL), at the UE 104, a transmit processor 964 may receive and process data from a data source. The transmit processor 964 may also generate reference symbols for a reference signal. The symbols from the transmit processor 964 may be precoded by a transmit MIMO processor 966 if applicable, further processed by the modulator/demodulators 954 and 955 (e.g., for single carrier-FDMA, etc.), and be transmitted to the base station 102 in accordance with the communication parameters received from the base station 102. At the base station 102, the UL signals from the UE 104 may be received by the antennas 934 and 935, processed by the modulator/demodulators 932 and 933, detected by a MIMO detector 936 if applicable, and further processed by a receive processor 938. The receive processor 938 may provide decoded data to a data output and to the processor(s) 940 or memory/memories 942.

The processor(s) 940 may in some cases execute stored instructions to instantiate a BS communicating component 442 (see e.g., FIGS. 1 and 4).

The components of the UE 104 may, individually or collectively, be implemented with one or more ASICs adapted to perform some or all of the applicable functions in hardware. Each of the noted modules may be a means for performing one or more functions related to operation of the MIMO communication system 900. Similarly, the components of the base station 102 may, individually or collectively, be implemented with one or more application specific integrated circuits (ASICs) adapted to perform some or all of the applicable functions in hardware. Each of the noted components may be a means for performing one or more functions related to operation of the MIMO communication system 900.

The following aspects are illustrative only and aspects thereof may be combined with aspects of other embodiments or teaching described herein, without limitation.

Aspect 1 is a method for wireless communication at a UE including transmitting, to a network node, UE capability information related to a number of SRSs to transmit for a number of antennas and a number of transmit chains at the UE, receiving, from the network node and based on the UE capability information, a SRS configuration of SRS resources for transmitting the number of SRSs, transmitting the number of SRSs over the SRS resources, and receiving, from the network node and based on transmitting the number of SRSs, an antenna selection indication related to a set of one or more of the number of antennas to be associated to the number of transmit chains for performing antenna selection at the UE.

In Aspect 2, the method of Aspect 1 includes where the UE capability information includes an indication of a SRS switching gap supported by the UE.

In Aspect 3, the method of any of Aspects 1 or 2 includes where receiving the antenna selection indication includes receiving the antenna selection indication as a number of bits indicating multiple ones of the set of one or more of the number of antennas to be associated to the number of transmit chains are selected in a MAC-CE.

In Aspect 4, the method of Aspect 3 includes selecting one of the multiple ones of the set of one or more of the number of antennas to be associated to the number of transmit chains for communicating with the network node.

In Aspect 5, the method of any of Aspects 3 or 4 includes receiving, from the network node, DCI indicating which one of the multiple ones of the set of one or more of the number of antennas to be associated to the number of transmit chains are selected for communicating with the network node.

In Aspect 6, the method of any of Aspects 3 to 5 includes where receiving the antenna selection indication includes receiving, in DCI, the antenna selection indication of which one of the set of one or more of the number of antennas to be associated to the number of transmit chains are selected for communicating with the network node.

In Aspect 7, the method of any of Aspects 1 to 6 includes where the UE capability information includes a first indication of the number of transmit chains at the UE and a second indication of a number of antenna switching cases supported at the UE.

In Aspect 8, the method of Aspect 7 includes where the SRS resources indicated in the SRS configuration include a number of SRS resources equal to the number of antenna switching cases each with the number of transmit chains for transmitting the number of SRSs.

In Aspect 9, the method of any of Aspects 1 to 8 includes where the UE capability information includes a first indication of the number of transmit chains at the UE, a second indication of a number of antennas, and an antenna switching support bitmap having a size corresponding to a number of antenna switching cases supported at the UE where each bit in the antenna switching support bitmap indicates whether a certain antenna switching selection is supported at the UE.

In Aspect 10, the method of Aspect 9 includes where the antenna switching support bitmap includes bits for antenna switching to support no constraint on an order of selected antennas with overlapping of antennas among chains permitted, no constraint on an order of selected antennas with overlapping of antennas among chains not permitted, a constraint on an order of selected antennas with overlapping of antennas among chains permitted, or a constraint on an order of selected antennas with overlapping of antennas among chains not permitted.

In Aspect 11, the method of Aspect 10 includes where the SRS resources indicated in the SRS configuration include a number of SRS resources equal to the number of antennas with one transmit chain for transmitting the number of SRSs.

In Aspect 12, the method of any of Aspects 10 or 11 includes where receiving the antenna selection indication includes receiving the antenna selection indication as a number of bits in another bitmap having the size corresponding to the antenna switching support bitmap, and indicating at least a portion of the certain antenna switching selections supported at the UE.

In Aspect 13, the method of any of Aspects 9 to 12 includes where the antenna switching support bitmap includes bits for antenna switching to support each transmit chain of the number of transmit chains connected to at least one of the number of antennas, or at least one transmit chain of the number of transmit chains not connected to any of the number of antennas.

In Aspect 14, the method of Aspect 13 includes where the SRS resources indicated in the SRS configuration include a number of SRS resources equal to the number of antennas divided by the number of transmit chains, each with one transmit chain, for transmitting the number of SRSs.

In Aspect 15, the method of any of Aspects 13 or 14 includes where receiving the antenna selection indication includes receiving the antenna selection indication as a number of bits in another bitmap having the size corresponding to the antenna switching support bitmap, and indicating at least a portion of the certain antenna switching selections supported at the UE.

Aspect 16 is a method for wireless communication at a network node including receiving, from a UE, UE capability information related to a number of SRSs to transmit for a number of antennas and a number of transmit chains at the UE, transmitting, based on the UE capability information, a SRS configuration of SRS resources for transmitting the number of SRSs, receiving, from the UE, the number of SRSs over the SRS resources, and transmitting, based on receiving the number of SRSs, an antenna selection indication related to a set of one or more of the number of antennas to be associated to the number of transmit chains for performing antenna selection at the UE.

In Aspect 17, the method of Aspect 16 includes where the UE capability information includes an indication of a SRS switching gap supported by the UE.

In Aspect 18, the method of any of Aspects 16 or 17 includes where transmitting the antenna selection indication includes transmitting the antenna selection indication as a number of bits indicating multiple ones of the set of one or more of the number of antennas to be associated to the number of transmit chains are selected in a MAC-CE.

In Aspect 19, the method of Aspect 18 includes transmitting DCI indicating which one of the multiple ones of the set of one or more of the number of antennas to be associated to the number of transmit chains are selected for communicating with the network node.

In Aspect 20, the method of any of Aspects 18 or 19 includes where transmitting the antenna selection indication includes transmitting, in DCI, the antenna selection indication of which one of the set of one or more of the number of antennas to be associated to the number of transmit chains are selected for communicating with the network node.

In Aspect 21, the method of any of Aspects 16 to 20 includes where the UE capability information includes a first indication of the number of transmit chains at the UE and a second indication of a number of antenna switching cases supported at the UE.

In Aspect 22, the method of Aspect 21 includes where the SRS resources indicated in the SRS configuration include a number of SRS resources equal to the number of antenna switching cases each with the number of transmit chains for transmitting the number of SRSs.

In Aspect 23, the method of any of Aspects 16 to 22 includes where the UE capability information includes a first indication of the number of transmit chains at the UE, a second indication of a number of antennas, and an antenna switching support bitmap having a size corresponding to a number of antenna switching cases supported at the UE where each bit in the antenna switching support bitmap indicates whether a certain antenna switching selection is supported at the UE.

In Aspect 24, the method of Aspect 23 includes where the antenna switching support bitmap includes bits for antenna switching to support no constraint on an order of selected antennas with overlapping of antennas among chains permitted, no constraint on an order of selected antennas with overlapping of antennas among chains not permitted, a constraint on an order of selected antennas with overlapping of antennas among chains permitted, or a constraint on an order of selected antennas with overlapping of antennas among chains not permitted.

In Aspect 25, the method of Aspect 24 includes where the SRS resources indicated in the SRS configuration include a number of SRS resources equal to the number of antennas with one transmit chain for transmitting the number of SRSs.

In Aspect 26, the method of any of Aspects 24 or 25 includes where transmitting the antenna selection indication includes transmitting the antenna selection indication as a number of bits in another bitmap having the size corresponding to the antenna switching support bitmap, and indicating at least a portion of the certain antenna switching selections supported at the UE.

In Aspect 27, the method of any of Aspects 23 to 26 includes where the antenna switching support bitmap includes bits for antenna switching to support each transmit chain of the number of transmit chains connected to at least one of the number of antennas, or at least one transmit chain of the number of transmit chains not connected to any of the number of antennas.

In Aspect 28, the method of Aspect 27 includes where the SRS resources indicated in the SRS configuration include a number of SRS resources equal to the number of antennas divided by the number of transmit chains, each with one transmit chain, for transmitting the number of SRSs.

In Aspect 29, the method of any of Aspects 27 or 28 includes where transmitting the antenna selection indication includes transmitting the antenna selection indication as a number of bits in another bitmap having the size corresponding to the antenna switching support bitmap, and indicating at least a portion of the certain antenna switching selections supported at the UE.

Aspect 30 is an apparatus for wireless communication including one or more processors, one or more memories coupled with the one or more processors, and instructions stored in the one or more memories and operable, when executed by the one or more processors, to cause the apparatus to perform any of the methods of Aspects 1 to 29.

Aspect 31 is an apparatus for wireless communication including means for performing any of the methods of Aspects 1 to 29.

Aspect 32 is one or more computer-readable media including code executable by one or more processors for wireless communications, the code including code for performing any of the methods of Aspects 1 to 29.

The above detailed description set forth above in connection with the appended drawings describes examples and does not represent the only examples that may be implemented or that are within the scope of the claims. The term “example,” when used in this description, means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and apparatuses are shown in block diagram form in order to avoid obscuring the concepts of the described examples.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, computer-executable code or instructions stored on a computer-readable medium, or any combination thereof.

The various illustrative blocks and components described in connection with the disclosure herein may be implemented or performed with a specially programmed device, such as but not limited to a processor, a digital signal processor (DSP), an ASIC, a field programmable gate array (FPGA) or other programmable logic device, a discrete gate or transistor logic, a discrete hardware component, or any combination thereof designed to perform the functions described herein. A specially programmed processor may be a microprocessor, but in the alternative, the processor may be any conventional processor, controller, microcontroller, or state machine. A specially programmed processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a non-transitory computer-readable medium. Other examples and implementations are within the scope and spirit of the disclosure and appended claims. For example, due to the nature of software, functions described above can be implemented using software executed by a specially programmed processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the common principles defined herein may be applied to other variations without departing from the spirit or scope of the disclosure. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise. Thus, the disclosure is not to be limited to the examples and designs described herein but is to be accorded the widest scope consistent with the principles and novel features disclosed herein.

What is claimed is:

1. An apparatus for wireless communication, comprising:
a transceiver;
one or more memories configured to, individually or in combination, store instructions; and
one or more processors communicatively coupled with the one or more memories, wherein the one or more processors are, individually or in combination, configured to execute the instructions to cause the apparatus to:
transmit, to a network node, user equipment (UE) capability information related to a number of sounding reference signals (SRSs) to transmit for a number of antennas and a number of transmit chains at the UE;
receive, from the network node and based on the UE capability information, a SRS configuration of SRS resources for transmitting the number of SRSs;
transmit the number of SRSs over the SRS resources; and
receive, from the network node and based on transmitting the number of SRSs, an antenna selection indication related to a set of one or more of the number of antennas to be associated to the number of transmit chains for performing antenna selection at the apparatus.

2. The apparatus of claim 1, wherein the UE capability information includes an indication of a SRS switching gap supported by the apparatus.

3. The apparatus of claim 1, wherein the one or more processors are, individually or in combination, configured to execute the instructions to cause the apparatus to receive the antenna selection indication as a number of bits indicating multiple ones of the set of one or more of the number of antennas to be associated to the number of transmit chains are selected in a media access control (MAC)-control element (CE).

4. The apparatus of claim 3, wherein the one or more processors are, individually or in combination, configured to execute the instructions to cause the apparatus to select one of the multiple ones of the set of one or more of the number of antennas to be associated to the number of transmit chains for communicating with the network node.

5. The apparatus of claim 3, wherein the one or more processors are, individually or in combination, configured to execute the instructions to cause the apparatus to receive, from the network node, downlink control information (DCI) indicating which one of the multiple ones of the set of one or more of the number of antennas to be associated to the number of transmit chains are selected for communicating with the network node.

6. The apparatus of claim 3, wherein the one or more processors are, individually or in combination, configured to execute the instructions to cause the apparatus to receive, in downlink control information (DCI), the antenna selection indication of which one of the set of one or more of the number of antennas to be associated to the number of transmit chains are selected for communicating with the network node.

7. The apparatus of claim 1, wherein the UE capability information includes a first indication of the number of transmit chains at the apparatus and a second indication of a number of antenna switching cases supported at the apparatus.

8. The apparatus of claim 7, wherein the SRS resources indicated in the SRS configuration include a number of SRS resources equal to the number of antenna switching cases each with the number of transmit chains for transmitting the number of SRSs.

9. The apparatus of claim 1, wherein the UE capability information includes a first indication of the number of transmit chains at the apparatus, a second indication of a number of antennas, and an antenna switching support bitmap having a size corresponding to a number of antenna switching cases supported at the apparatus where each bit in the antenna switching support bitmap indicates whether a certain antenna switching selection is supported at the apparatus.

10. The apparatus of claim 9, wherein the antenna switching support bitmap includes bits for antenna switching to support:
no constraint on an order of selected antennas with overlapping of antennas among chains permitted;
no constraint on an order of selected antennas with overlapping of antennas among chains not permitted;
a constraint on an order of selected antennas with overlapping of antennas among chains permitted; or
a constraint on an order of selected antennas with overlapping of antennas among chains not permitted.

11. The apparatus of claim 10, wherein the SRS resources indicated in the SRS configuration include a number of SRS resources equal to the number of antennas with one transmit chain for transmitting the number of SRSs.

12. The apparatus of claim 10, wherein the one or more processors are, individually or in combination, configured to execute the instructions to cause the apparatus to receive the antenna selection indication as a number of bits in another bitmap having the size corresponding to the antenna switching support bitmap, and indicating at least a portion of the certain antenna switching selections supported at the UE.

13. The apparatus of claim 9, wherein the antenna switching support bitmap includes bits for antenna switching to support:
each transmit chain of the number of transmit chains connected to at least one of the number of antennas; or
at least one transmit chain of the number of transmit chains not connected to any of the number of antennas.

14. The apparatus of claim 13, wherein the SRS resources indicated in the SRS configuration include a number of SRS resources equal to the number of antennas divided by the number of transmit chains, each with one transmit chain, for transmitting the number of SRSs.

15. The apparatus of claim 13, wherein the one or more processors are, individually or in combination, configured to execute the instructions to cause the apparatus to receive the antenna selection indication as a number of bits in another bitmap having the size corresponding to the antenna switching support bitmap, and indicating at least a portion of the certain antenna switching selections supported at the apparatus.

16. An apparatus for wireless communication, comprising:
a transceiver;
one or more memories configured to, individually or in combination, store instructions; and
one or more processors communicatively coupled with the one or more memories, wherein the one or more processors are, individually or in combination, configured to execute the instructions to cause the apparatus to:
receive, for a user equipment (UE), UE capability information related to a number of sounding reference signals (SRSs) to transmit for a number of antennas and a number of transmit chains at the UE;
transmit, based on the UE capability information, a SRS configuration of SRS resources for transmitting the number of SRSs;
receive, for the UE, the number of SRSs over the SRS resources; and
transmit, based on receiving the number of SRSs, an antenna selection indication related to a set of one or more of the number of antennas to be associated to the number of transmit chains for performing antenna selection at the UE.

17. The apparatus of claim 16, wherein the UE capability information includes an indication of a SRS switching gap supported by the UE.

18. The apparatus of claim 16, wherein the one or more processors are, individually or in combination, configured to execute the instructions to cause the apparatus to transmit the antenna selection indication as a number of bits indicating multiple ones of the set of one or more of the number of antennas to be associated to the number of transmit chains are selected in a media access control (MAC)-control element (CE).

19. The apparatus of claim 18, wherein the one or more processors are, individually or in combination, configured to execute the instructions to cause the apparatus to transmit downlink control information (DCI) indicating which one of the multiple ones of the set of one or more of the number of antennas to be associated to the number of transmit chains are selected for communicating with the apparatus.

20. The apparatus of claim 18, wherein the one or more processors are, individually or in combination, configured to execute the instructions to cause the apparatus to transmit, in downlink control information (DCI), the antenna selection indication of which one of the set of one or more of the number of antennas to be associated to the number of transmit chains are selected for communicating with the apparatus.

21. The apparatus of claim 16, wherein the UE capability information includes a first indication of the number of transmit chains at the UE and a second indication of a number of antenna switching cases supported at the UE.

22. The apparatus of claim 21, wherein the SRS resources indicated in the SRS configuration include a number of SRS resources equal to the number of antenna switching cases each with the number of transmit chains for transmitting the number of SRSs.

23. The apparatus of claim 16, wherein the UE capability information includes a first indication of the number of transmit chains at the UE, a second indication of a number of antennas, and an antenna switching support bitmap having a size corresponding to a number of antenna switching cases supported at the UE where each bit in the antenna switching support bitmap indicates whether a certain antenna switching selection is supported at the UE.

24. The apparatus of claim 23, wherein the antenna switching support bitmap includes bits for antenna switching to support:
no constraint on an order of selected antennas with overlapping of antennas among chains permitted;
no constraint on an order of selected antennas with overlapping of antennas among chains not permitted;
a constraint on an order of selected antennas with overlapping of antennas among chains permitted; or
a constraint on an order of selected antennas with overlapping of antennas among chains not permitted.

25. The apparatus of claim 24, wherein the one or more processors are, individually or in combination, configured to execute the instructions to cause the apparatus to transmit the antenna selection indication as a number of bits in another bitmap having the size corresponding to the antenna switching support bitmap, and indicating at least a portion of the certain antenna switching selections supported at the UE.

26. The apparatus of claim 23, wherein the antenna switching support bitmap includes bits for antenna switching to support:
each transmit chain of the number of transmit chains connected to at least one of the number of antennas; or
at least one transmit chain of the number of transmit chains not connected to any of the number of antennas.

27. A method for wireless communication at a user equipment (UE), comprising:
transmitting, to a network node, UE capability information related to a number of sounding reference signals (SRSs) to transmit for a number of antennas and a number of transmit chains at the UE;
receiving, from the network node and based on the UE capability information, a SRS configuration of SRS resources for transmitting the number of SRSs;
transmitting the number of SRSs over the SRS resources; and
receiving, from the network node and based on transmitting the number of SRSs, an antenna selection indication related to a set of one or more of the number of antennas to be associated to the number of transmit chains for performing antenna selection at the UE.

28. The method of claim 27, wherein the UE capability information includes an indication of a SRS switching gap supported by the UE.

29. A method for wireless communication at a network node, comprising:
receiving, from a user equipment (UE), UE capability information related to a number of sounding reference signals (SRSs) to transmit for a number of antennas and a number of transmit chains at the UE;
transmitting, based on the UE capability information, a SRS configuration of SRS resources for transmitting the number of SRSs;
receiving, from the UE, the number of SRSs over the SRS resources; and
transmitting, based on receiving the number of SRSs, an antenna selection indication related to a set of one or more of the number of antennas to be associated to the number of transmit chains for performing antenna selection at the UE.

30. The method of claim 29, wherein the UE capability information includes an indication of a SRS switching gap supported by the UE.
